(19) United States
(12) Patent Application Publication
(10) Pub. No.: US 2006/0081381 A1
(43) Pub. Date: Apr. 20, 2006

(54) Material handling apparatus

(75) Inventors: Scott Westmont, Reno, NV (US); Harry C. Anderson II, Carnelian Bay, CA (US)

Correspondence Address: FOLEY & LARDNER LLP, 777 EAST WISCONSIN AVENUE, SUITE 3800, MILWAUKEE, WI, 53202-5308, US

(73) Assignee: Kassbohrer All Terrain Vehicles, Inc.

(21) Appl. No.: 10/935,619

(22) Filed: Sep. 7, 2004

(51) Int. Cl. A01B 63/00

(52) U.S. Cl. 172/247

(57) ABSTRACT

A method and apparatus for material handling coupled to a vehicle to move material and an object. The material handling apparatus comprises a blade movably attached to the vehicle and configured to move the material and move relative to the vehicle. A pair of forks is coupled to the blade and configured to move from one position wherein the forks form a portion of the blade to a second position wherein the forks can selectively manipulate the object. The material handling apparatus can include actuators to move the blade and the forks. The apparatus can also be configured wherein the actuators are controlled from inside the vehicle.

### BACKGROUND OF THE INVENTION

The present invention relates to terrain grooming equipment, and more particularly to a material handling apparatus coupled to a vehicle to move material and an object and specifically to move such material and an object in a snow or sand field. The present invention also relates to moving of material and objects in agricultural, construction and landscaping fields of use.

The ski industry has seen a dramatic increase in the number of snowboarders. Many “ski” facilities now cater not only to downhill skiers, but also to cross-country skiers as well as snowboarders. Specifically with respect to snowboarders, a new focus on snow grooming is important. As snowboarding became more prevalent, snowboarders used picnic tables, railings, fallen trees and any item that they could get their hands on to create features for jumping, sliding and “getting air.” Ski facilities develop half pipes, rail slides, fun boxes and other snowboard terrain park features to accommodate the needs and desires of the snowboarding customers. This trend expanded to include skiers as well in the new terrain parks.

Moving the various rail slides, fun boxes and other items from one location to another and to allow at the same time the grooming of the snow field, create special challenges to the operator. Moving the terrain park feature to the hill or location and moving the feature after snow storms or for rebuilding and grooming of the park is a problem. Movement of the vehicle over the snow typically requires a broad continuous track, such as a so-called snow cat vehicle to distribute the weight and not unduly compact the snow. Many of the terrain park features or objects, such as rail slides and fun boxes, can be as much as 50 feet long and weigh up to 2,000 pounds. Conventional methods for moving such features has been to weld hooks onto the machine's blade or to use strapping with ratchet type adjustments to secure objects to the blade to move them to a specific location. Such procedures can cause damage to the features or the machine moving the feature and can create dangerous situations for operators. Vehicles such as forklifts or high-lift vehicles are not practical on snow. Such vehicles also increase the capital cost to a snow park operator since they would need a standard grooming machine as well as a forklift machine.

Thus, there is a need for a material handling apparatus that can function as a conventional blade to move material such as by plowing and moving and placing objects from one location to another. There is a further need for a material handling apparatus that can be operated from inside the cab of the vehicle. There is further need for a material handling apparatus that can be used with snow, sand, dirt or the like.

### SUMMARY OF THE INVENTION

There is provided a material handling apparatus coupled to a vehicle to move material and an object. The material handling apparatus comprises a blade movably attached to the vehicle and configured to move the material and move relative to the vehicle. A pair of forks is coupled to the blade and configured to move from one position wherein the forks form a portion of the blade to a second position wherein the forks can selectively manipulate the object. The material handling apparatus can include actuators to move the blade and the forks. The apparatus can also be configured wherein the actuators are controlled from inside the vehicle.

There is also provided a vehicle configured to move material and an object. The vehicle comprises a support platform with the supporting member coupled to the support platform and configured to maintain the support platform a selected distance from a surface. A material handling apparatus is coupled to the support platform and configured to selectively contact the surface. The material handling apparatus comprises a blade movably attached to the support platform and configured to move the material and to move relative to the support platform. A pair of forks is coupled to the blade and configured to move from one position wherein the forks form a portion of the blade to a second position wherein the forks can selectively manipulate the object.

There is also provided a method for moving material and moving an object from inside a vehicle. A method comprising the steps of providing a blade configured to move material and to move relative to the vehicle. Coupling the blade to the vehicle. Providing a pair of forks. Coupling the forks to the blade, wherein the forks are configured to move from one position wherein the forks form a portion of the blade to a second position wherein the forks can selectively manipulate the object, with the movement of the forks controlled from inside the vehicle. Another embodiment of the method includes the step of configuring the blade to push one of snow and sand.

### BRIEF DESCRIPTION OF THE DRAWINGS

FIG. 1 is a side plan view of a vehicle on a surface, the vehicle having an exemplary embodiment of a material handling apparatus coupled to the vehicle.

FIG. 2 is a perspective front view of an exemplary embodiment of the material handling apparatus, including a pair of blades in a first position forming a portion of the blade.

FIG. 3 is a perspective front view of the material handling apparatus illustrated in FIG. 2, with the blades in a second position to selectively manipulate an object.

FIG. 4 is a partial top view of an exemplary embodiment of a material handling apparatus having blades in a second position to manipulate an object and illustrating actuators coupled to the forks and blade at the backside of the blade.

FIG. 5 is a partial top view of the material handling apparatus illustrated in FIG. 4 having the blades in a first position forming a portion of the blade and illustrating the actuators coupled to the forks and blade at the backside of the blade.

FIG. 6 is a perspective front view of an alternative embodiment of a material handling apparatus, including a pair of forks in a first position forming a portion of the blade, with the forks configured to hold an object.

FIG. 7 is a partial side view of the material handling apparatus illustrated in FIG. 6 illustrating a fork in a second position (solid lines) when the actuator is in an extended position and the fork is in a first position (broken lines) when the actuator is in a retracted position.

FIG. 8 is a partial side view of the material handling apparatus illustrated in FIG. 6 illustrating an alternative linkage wherein, with the actuator in an extended position the fork is in the first position (solid lines) and with the actuator in a retracted position the fork is in the second position (broken lines).

FIG. 9 is a perspective front view of an alternative embodiment of a material handling apparatus, including a pair of forks proximate the lower edge of the blade with the forks in a first position forming a portion of the blade.

FIG. 10 is a perspective front view of an alternative embodiment of a material handling apparatus, including a pair of forks in a second position to selectively manipulate an object, with the forks coupled to a channel mounted to the front side of the blade.

### DETAILED DESCRIPTION OF THE EXEMPLARY EMBODIMENTS

Before discussing exemplary embodiments of a material handling apparatus 15 for a vehicle 5, there are a few preliminary comments. When referring to a vehicle 5, it is contemplated that a vehicle 5 can be of several different uses and can be referred to as a work vehicle 5, a snow cat 5, a Park Bully® 5, a multi-wheel vehicle 5, wheel loader, bulldozer or the like. It is also contemplated that articulated tracks 10 mounted on the wheels 9 can be used as a support for the support structure 6 of the vehicle 5. The vehicle 5 also typically has an area designated as a vehicle front, vehicle side and includes a vehicle body which may define a vehicle cab 1. It is contemplated that any convenient and conventional materials can be utilized for such vehicle portions commensurate with the type of duty that will be experienced by such vehicle. For example, the body can be made out of steel, aluminum, composite materials or a combination of such materials. The wheels 9 can be cast or machined, etc. At least one wheel set can be steerable and at least two wheels are coupled to a drive motor. The drive motor may include a turbine engine, an electronic motor, an internal combustion engine, a hybrid-electric system or any combination of such devices.

For purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. By way of example, ground-engaging motive members 10 may be coupled to support structure 6 by a suspension system such that support structure 6 is supported relative to each surface engaging motive member.

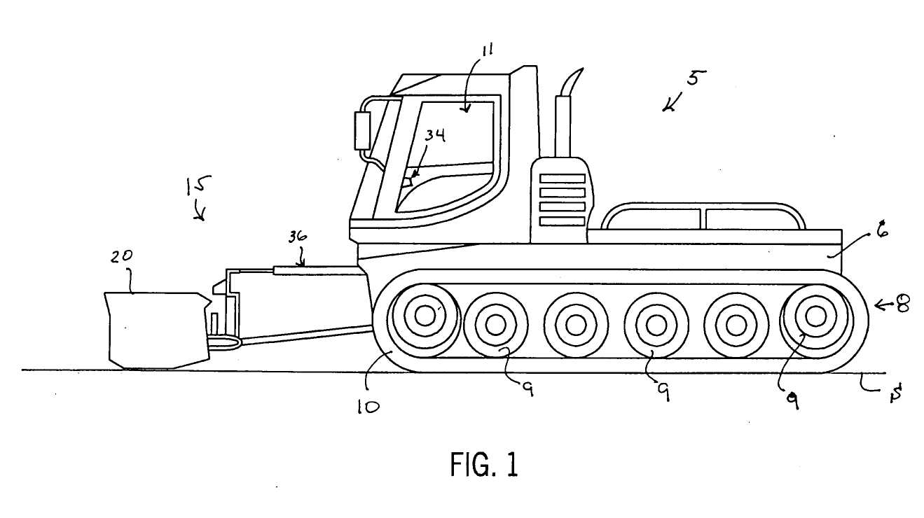

Referring to the figures, FIG. 1 shows a vehicle 5 having a vehicle cab 11 supported on a support platform 6. The support platform is coupled to a plurality of supporting members 8 which maintain the support platform 6 a selected distance from the surface, for example such as sand or snow. The supporting members 8 include wheels 9 which support a track system 10, for example an endless track, which are conducted over the wheels 9.

A material handling apparatus 15 is coupled to the support platform 6 and is configured to selectively contact the surface, for example snow, sand or dirt.

The material handling apparatus 15 includes a blade 20 which is movably attached to the vehicle 5. The blade is configured to move material such as snow, sand and dirt and is also configured to move relative to the vehicle 5. The blade 20 can be moved in a vertical direction and it can be pivoted either to the left or the right as determined by the operator of the vehicle 5. Appropriate actuators 36 are coupled to the blade 20 and vehicle 5 to facilitate such movements. The blade 20 can be composed of metal, such as steel or aluminum, or a composite material, or a combination of such materials. For purposes of this application, the term “blade” shall include shovel, scoop, rake and similar tool.

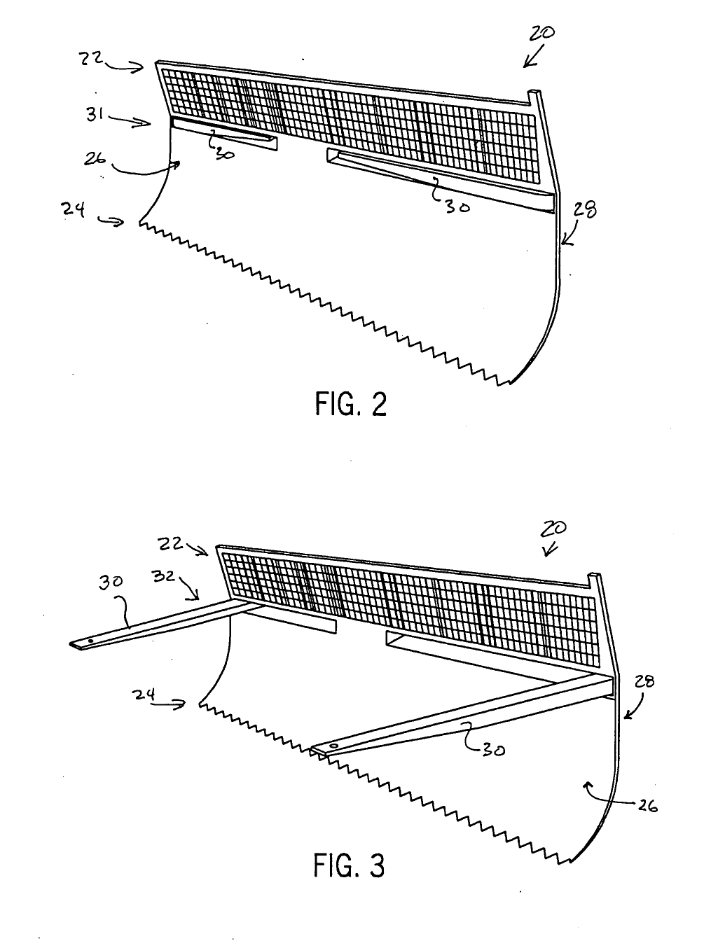

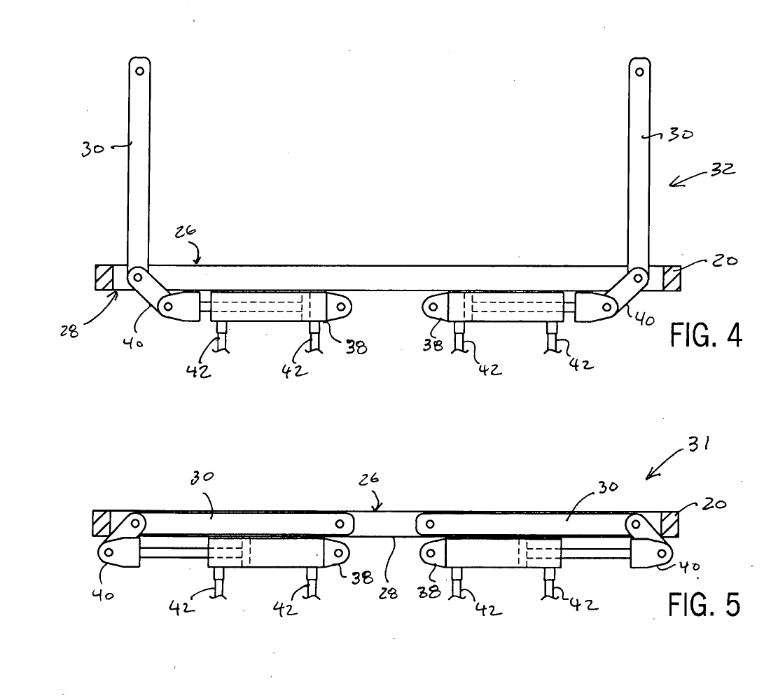

A pair of forks 30, also referenced to as lift arms, are coupled to the blade 20 and configured to move from one position 31 wherein the forks 30 form a portion of the blade 20, to a second position 32 wherein the forks 30 can selectively manipulate the object. (See FIGS. 2 and 3.) The forks 30 can be composed of metal, such as steel or aluminum, or a composite material, or a combination of such materials.

In FIGS. 1 and 2, the fork 30 are in a first position 31 which form a part of the blade 20. In this position, the blade 20 is moved by the vehicle 5 and materials such as snow, sand, rock and dirt may be pushed by the blade 20 like a conventional bulldozer. When the forks 30 are moved to a second position 32, the forks 30 can be used to selectively manipulate an object such as the terrain park features. An operator of the material handling apparatus 15 moves the vehicle 5 to the feature to be manipulated, engages the object with the forks 30 and lifts the forks 30 and the object with the blade 20 and moves the feature and object to a pre-selected location.

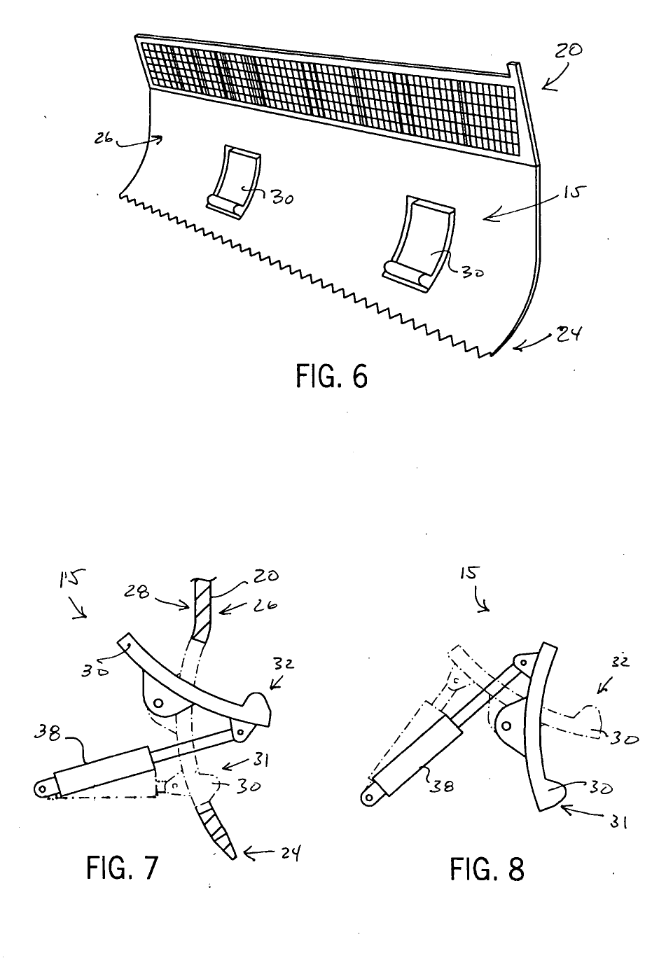

Movement of the fork 30 is facilitated by a set of actuators coupled to the blade 20 and each fork 30. (See FIGS. 5 and 6.) The actuators are coupled to a control apparatus 34 which can be located inside or outside the operator's cab 11. The control apparatus 34 can be a set of valves that are operated manually or by electric motors or solenoids. It is also contemplated that control of the actuators 36, 38 can be done by wireless remote control utilizing radio, infrared or other electromagnetic wave technology.

Appropriate control conduits 42 connect the actuators 36, 38 to the control apparatus 34 and the source of energy. For example, if the actuators 36, 38 are hydraulic cylinders, the control conduit 42 would be hoses coupled to valves in the control apparatus 34 as well as through an appropriate pump and sump. The actuators 36, 38 may also be pneumatic cylinders, or electrically powered servo motors, or screw-type apparatus. Appropriate linkage 40 couples the actuator 36, 38 to the blade 20 and the forks 30.

FIGS. 6-8 illustrate an alternative embodiment of a material handling apparatus 15. In such alternative embodiment, the forks 30 are a broad plate that conform substantially to the shape of the blade 20 and are configured to hold the object being moved. In the illustrated embodiment, a raised ridge formed along the lower edge of the fork 30 provides a lift to retain or hold an object placed or engaged by the forks 30. FIGS. 7 and 8 illustrate alternative means for actuating the forks 30 and moving them from a first position 31 to a second position 32.

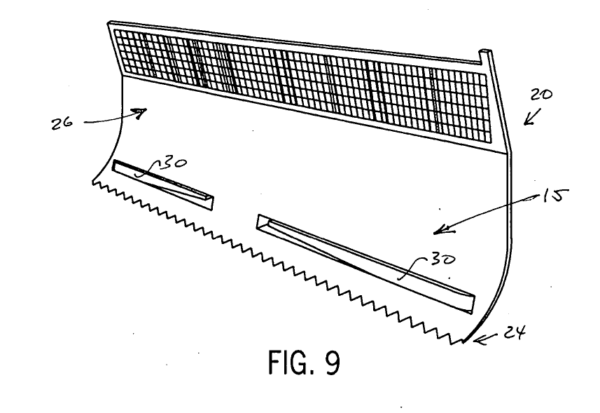

FIG. 9 illustrates an alternative embodiment of a material handling apparatus 15. In such configuration, the forks 30 are proximate the lower edge 24 of the blade 20. Such configuration is in contrast to the material handling apparatus 15 illustrated in FIG. 2 wherein the forks 30 are coupled to the blade 20 proximate the upper edge 22 of the blade 20.

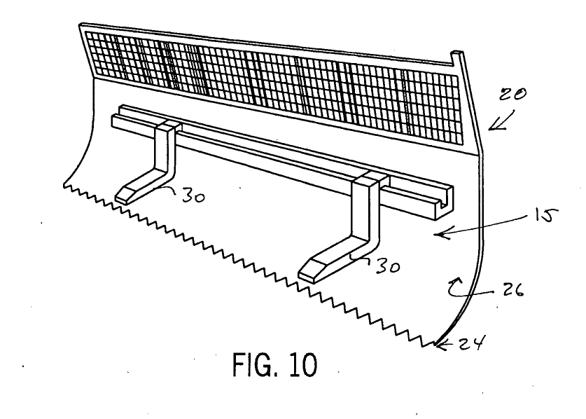

FIG. 10 illustrates an alternative embodiment of a material handling apparatus. A channel is coupled to the blade 20 with a pair of forks 30 hung on the channel. Movement of the forks 30 within the channel can be facilitated by actuators coupled to the forks 30 and manipulated from the cab 11 by an operator. It is also contemplated that the forks 30, in this embodiment, can be manually moved to a pre-determined position and locked in place with a pin or a notch in the channel.

It should be understood that it is also contemplated that the forks 30 can be mounted to the blade 20 in other configurations and locations, for example, a fork along each side edge of the blade 20 with the forks moving vertically. It is also contemplated that more than two forks can be used with the blade 20 with appropriate actuators and linkages to facilitate movement of the forks relative to the blade 20. It should also be understood that the blade 20 may include wing attachments (not shown) to facilitate the snow and sand grooming function of the vehicle 5.

In operation, an operator would drive the vehicle 5 over the snow field to an object such as a snowboard terrain park rail, extend the forks 30 to the position to selectively manipulate the object, lifting the blade 20 and forks 30 thereby lifting the object, driving the vehicle 5 to a second preselected position, lowering the blade 20, thereby lowering the object to the new position. The driver would then retract the forks 30 so that the forks formed a portion of the blade 20 and then use the blade in a typical fashion to push or pull the snow or other material, such as dirt, rock and sand to a desired topography.

Thus, there is disclosed a material handling apparatus coupled to a vehicle that can be used to move material, such as sand, rock, snow or dirt and to selectively manipulate an object as determined by an operator inside the vehicle. The foregoing description of several embodiments has been presented for purposes of illustration and description. It is not intended to be exhaustive or limited to the precise forms disclosed, and modifications and variations are possible in light of the above teachings or may be required for the practice of the invention. The embodiments were chosen and described in order to explain the principles of the invention and the practical application to enable one skilled in the art to utilize the invention's various embodiments and with various modifications as are suited to the particular use contemplated. It is contemplated that the material handling apparatus can be provided with additional attachments as selected by the operator. It is also contemplated that the forks can be fitted with manipulative devices such as hooks, eyelets, extensions, grappling devices, or material transportation devices, (for example, garbage carts, bins, etc.) to further facilitate the movement, placement and manipulation of objects. It is intended that the scope of the invention be defined by the claims appended hereto and their equivalents.

What is claimed is:

1. A material handling apparatus coupled to a vehicle to move material and an object, the apparatus comprising:
a blade movably attached to the vehicle and configured to move the material and to move relative to the vehicle; and
a pair of forks coupled to the blade and configured to move from one position wherein the forks form a portion of the blade to a second position wherein the forks can selectively manipulate the object.

2. The material handling apparatus of claim 1, including a first actuator coupled to the vehicle and the blade.

3. The material handling apparatus of claim 1, including a second actuator coupled to the blade and each fork.

4. The material handling apparatus of claim 2 or 3, wherein the actuators are controlled from inside the vehicle.

5. The material handling apparatus of claim 1, wherein the blade is configured to push snow.

6. The material handling apparatus of claim 1, wherein the blade is configured to push sand.

7. The material handling apparatus of claim 1, wherein the forks are configured to hold the object.

8. A vehicle configured to move material and an object, the vehicle comprising:
a support platform;
a supporting member coupled to the support platform and configured to maintain the support platform a selected distance from a surface; and
a material handling apparatus coupled to the support platform and configured to selectively contact the surface, the material handling apparatus comprising:
a blade movably attached to the support platform and configured to move the material and to move relative to the support platform; and
a pair of forks coupled to the blade and configured to move from one position wherein the forks form a portion of the blade to a second position wherein the forks can selectively manipulate the object.

9. The vehicle of claim 8, including a first actuator coupled to the vehicle and the blade.

10. The vehicle of claim 8, including a second actuator coupled to the blade and each fork.

11. The vehicle claim 9 or 10, wherein the actuators are controlled from inside the vehicle.

12. The vehicle of claim 8, wherein the blade is configured to push snow.

13. The vehicle of claim 8, wherein the blade is configured to push sand.

14. The vehicle of claim 8, wherein the forks are configured to hold the object.

15. The vehicle of claim 8, wherein the supporting member is a driven wheel.

16. The vehicle of claim 15, wherein the wheel is coupled to a track system.

17. A method for pushing material and moving an object from inside a vehicle, the method comprising the steps of:
providing a blade configured to move material and to move relative to the vehicle;
coupling the blade to the vehicle;
providing a pair of forks; and
coupling the forks to the blade, wherein the forks are configured to move from one position wherein the forks form a portion of the blade, to a second position wherein the forks can selectively manipulate the object, with the movement of the forks controlled from one of the outside and inside the vehicle.

18. The method of claim 17, including the steps of providing a first actuator, coupling the first actuator to the blade and the vehicle, and controlling the first actuator from inside the vehicle.

19. The method of claim 18, including the steps of providing a second actuator, coupling the second actuator to the blade and each of the forks, and controlling the second actuator from inside the vehicle.

20. The method of claim 17, including the step of configuring the blade to push one of snow, rock, sand and dirt.
